(19) United States
(12) Patent Application Publication
(10) Pub. No.: US 2005/0020248 A1
(43) Pub. Date: Jan. 27, 2005

(54) Telecommunications terminal and method for operating a telecommunications terminal

(76) Inventor: Thomas Wellhausen, Berlin (DE)

Correspondence Address: LERNER AND GREENBERG, P.A., POST OFFICE BOX 2480, HOLLYWOOD, FL, 33022-2480, US

(21) Appl. No.: 10/776,362

(22) Filed: Feb. 10, 2004

(30) Foreign Application Priority Data
Jul. 21, 2003 (DE) 103 33 900.0

(51) Int. Cl. H04Q 7/20

(52) U.S. Cl. 455/412.2

(57) ABSTRACT

To provide the functional and setting parameters required for operation of a telecommunications terminal, as well as general telecommunications data and individual user data independently of the operation of the telecommunications terminal, the invention stores the data, functional, and setting parameters on a Universal Serial Bus memory stick, which can be connected to the telecommunications terminal through a USB interface. The functional and setting parameters as well as other operating and individual user data can, in this way, be transmitted to another telecommunications terminal in the event of servicing, repair, or replacement so that no data is lost nor is any service technician required for setting up and adjusting the telecommunications terminal, with the telecommunications terminal in situ.

### BACKGROUND OF THE INVENTION

### FIELD OF THE INVENTION

The invention relates to a telecommunications terminal having an apparatus for storage of data, functional, and setting parameters for the telecommunications terminal.

Telecommunications terminals carry out a wide range of functions and, in addition to the functional and setting parameters that are required for the operation and access authorization, they also individually store setting parameters for the user and the data which is entered or predetermined by the user, for example, in the form of a telephone or address book, short messages in the SMS format, passwords, and the like. If data such as this, as well as functional and setting parameters, are not continuously also stored externally by, for example, being transmitted through an infrared interface, or radio data transmission (Bluetooth), or through a cable data transmission path to some other terminal or to a computer processing device, then such data is entirely or partially lost in the event of a defect or during servicing.

In addition, when changing to a different telecommunications terminal, the user is frequently faced with the problem of the data formats not being compatible so that complex conversions are required, or complete re-entry of the data, functional, and setting parameters as in the case of a defect or servicing.

International publication WO 01/39473 A1 discloses a mobile telephone with a decoder for reproduction of audio data that, inter alia, has a permanently installed or plug-in memory unit for storage of audio data, which is coded using a compressed digital audio format and is stored by the mobile telephone in an internal or plug-in memory unit that includes a slot card, a card with a FLASH memory or memory module that is referred to as a “memory stick”, and is connected through an internal digital interface to a permanently installed memory unit and to a microprocessor control unit, which drives the interface module that provides an external digital interface, for example, a Universal Serial Bus (USB) or a IrDA interface or a Bluetooth interface.

### SUMMARY OF THE INVENTION

It is accordingly an object of the invention to provide a telecommunications terminal and a method for operating a telecommunications terminal that overcome the hereinafore-mentioned disadvantages of the heretofore-known devices and methods of this general type and that provides the functional and setting parameters required for operation of a telecommunications terminal, as well as general telecommunications data and individual user data independently of the operation of the telecommunications terminal.

With the foregoing and other objects in view, there is provided, in accordance with the invention, a telecommunications terminal, including a bi-directional communication device having data, functional, and setting parameters, a storage apparatus connected to the communication device and storing the data, functional, and setting parameters of the communication device, a Universal Serial Bus (USB) interface connected to at least one of the communication device and the storage apparatus, a USB memory stick removably connected to the USB interface, and the storage apparatus storing the data, functional and setting parameters of the communication device on the USB memory stick through the USB interface.

With the objects of the invention in view, there is also provided a telecommunications terminal, including a bi-directional communication device having data, functional, and setting parameters, a Universal Serial Bus (USB) interface, a USB memory stick removably connected to the USB interface, and a means for storing the data, functional, and setting parameters of the communication device on the USB memory stick through the USB interface, the storage means connected to the communication device and to the USB interface.

With the objects of the invention in view, there is also provided a telecommunications terminal, including a bi-directional communication device having data, functional, and setting parameters, a Universal Serial Bus (USB) interface connected to the communication device, and a USB memory stick removably connected to the USB interface, the USB memory stick storing the data, functional, and setting parameters of the communication device and selectively transmitting the data, functional, and setting parameters of the communication device to the communication device through the USB interface.

With the objects of the invention in view, there is also provided a telecommunications terminal, including a bi-directional communication device having data, functional, and setting parameters, a Universal Serial Bus (USB) interface connected to the communication device, a USB memory stick removably connected to the USB interface, the USB memory stick storing the data, functional, and setting parameters of the communication device, and the communication device reading the data, functional, and setting parameters from the USB memory stick through the USB interface.

With the objects of the invention in view, there is also provided a telecommunications terminal, including a Universal Serial Bus (USB) interface to be connected to a USB memory stick and an apparatus for storing data, functional, and setting parameters for the telecommunications terminal connected to the USB interface, the apparatus storing the parameters on the USB memory stick when connected to the USB interface.

With the objects of the invention in view, there is also provided a method for operating a telecommunications terminal, including providing a bi-directional communication device with data, functional, and setting parameters and a Universal Serial Bus (USB) interface, removably connecting a USB memory stick to the USB interface, and storing the data, functional, and setting parameters of the communication device on the USB memory stick through the USB interface.

According to the invention, the data, functional, and setting parameters are stored on a USB memory stick, which can be connected to the telecommunications terminal through a USB interface.

The solution according to the invention provides the functional and setting parameters that are required for operation of a telecommunications terminal, as well as general telecommunications data and individual user data independently of the operation of the telecommunications terminal. Consequently, in the event of servicing, repair, or replacement, the functional and setting parameters as well as other operational and individual user data can be transmitted to some other telecommunications terminal so that no data is lost nor is a servicing technician required for setting up and adjusting the telecommunications terminal with the telecommunications terminal in situ.

In accordance with another feature of the invention, the USB memory stick stores data for the communication device selected from at least one of the group consisting of telephone book data, short messages data, access code data, authorization data, and authorization words.

In accordance with a further feature of the invention, the communication device has functional parts and the USB memory stick is connected to the functional parts through the USB interface.

In accordance with an added feature of the invention, the communication device has an internal memory unit and the USB memory stick is connected to the memory unit through the USB interface.

The functional and setting parameters as well as the other data can be provided exclusively through the USB memory stick or in conjunction with an internal memory device in the telecommunications terminal.

In the first case, the functionality and operational readiness of the telecommunications terminal depends on the USB memory stick, which is inserted into the telecommunications terminal through an appropriate interface, for example, through a USB port, while, in the case of a combination with an internal memory device in the telecommunications terminal with a USB memory stick that is connected to the telecommunications terminal, it is, in such a case, possible to update or to adjust the database, and operation independently of the USB memory stick is also possible.

However, because the functional and setting parameters for the telecommunications terminal are always stored on the USB memory stick, the telecommunications terminal could be replaced in the event of a failure or a defect without any need for a servicing technician, and there is no need to re-enter functional and setting parameters as well as the individual data, but only for the user to update the database.

The USB memory stick may either be integrated in the telecommunications terminal or may be fitted with some suitable form to the housing of the telecommunications terminal, and may be connected to the telecommunications terminal, and to its power supply, through an interface and, possibly, through a USB controller.

In accordance with an additional feature of the invention, the internal memory unit of the telecommunications terminal is a RAM or FLASH memory with suitable control parameters for the electronic data processing components of the telecommunications terminal.

In accordance with yet another feature of the invention, the USB memory stick is a USB memory stick duo.

In accordance with yet a further feature of the invention, there is provided a USB controller and the USB memory stick is connected to the USB interface through the USB controller.

In accordance with yet an added feature of the invention, there is provided a serial memory and the USB controller is connected to the serial memory. Preferably, the serial memory is an EEPROM.

In accordance with yet an additional feature of the invention, the USB memory stick has a serial memory connected to the USB controller. Preferably, the serial memory is an EEPROM.

In accordance with again another feature of the invention, there is provided a housing having an insert slot configured to removably receive the USB memory stick and the communication device, the storage apparatus and the USB interface are disposed in the housing.

In accordance with again a further feature of the invention, the USB memory stick is lockably connected to the USB interface.

To connect the USB memory stick to the telecommunications terminal, the USB memory stick may be inserted into an insert slot in the telecommunications terminal such that it ends flush with one housing face of the telecommunications terminal. Furthermore, the USB memory stick that is inserted into the telecommunications terminal may be locked to secure the connection to the telecommunications terminal.

In accordance with a concomitant feature of the invention, the communication device is selected from the group consisting of a cordless telephone, a DECT Standard cordless telephone, a table telephone, and a mobile telephone.

Other features that are considered as characteristic for the invention are set forth in the appended claims.

Although the invention is illustrated and described herein as embodied in a telecommunications terminal and a method for operating a telecommunications terminal, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a diagrammatic plan view of a telecommunications terminal in the form of a mobile part; and

FIG. 2 is a block circuit diagram of functional parts of the telecommunications terminal of FIG. 1.

### DESCRIPTION OF THE PREFERRED EMBODIMENTS

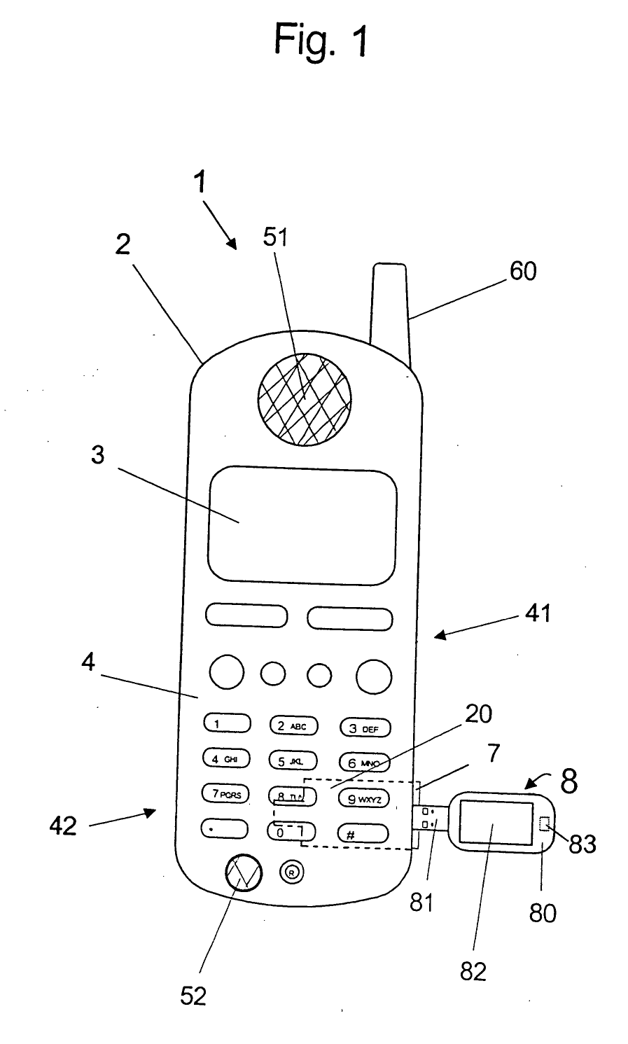

Referring now to the figures of the drawings in detail and first, particularly to FIG. 1 thereof, there is shown a schematic plan view of a mobile part 1 of a telecommunications terminal with a housing 2 and with an antenna 60 that projects from the housing 2 of the mobile part 1 and is connected through a radio transmission path to a base station for the telecommunications terminal. The base station is connected to telephone lines for a telecommunications network or to a telephone system. A display 3, a keypad 4 with functional keys 41 and numerical keys 42, a loudspeaker (earpiece) 51, and a microphone 52 are disposed on the front face of the housing 2. The display 3 indicates both states of the mobile part 1, such as the state of charge of the rechargeable battery and the reception field strength of the mobile part, as well as the functions of the display keys at the time, as well as the network provider, a caller list, internal calls, redialing, and the like, as well as personal data stored by the user, such as telephone book and address book entries, transmitted and received “SMS”, programmed inputs, and the like.

The functional keys 41 include not only display keys for the network provider, a caller list, internal calls, redialing, muting, switching on a hands-free device, and the like, but also programming keys for calling service features in a programming tree such as “destination programming”, “ringing”, “key inhibit”, “direct call”, “amend secret number”, “check call units and delete”, as well as a back key, which makes it possible to jump back to the previous sub-routine in the programming tree. The numerical keys 42 are used for entering call numbers as well as for entering letters and digits for programming processes.

These user inputs, which may be programmed, are, according to the prior art, stored together with the functional and setting parameters for the telecommunications terminal in an internal memory in the telecommunications terminal, and are, thus, a fixed component of the telecommunications terminal so that, in the event of a defect or if it is necessary to replace the telecommunications terminal, the stored data, functional and setting parameters are lost. While the functional and setting parameters must then be re-entered by a specialist in a time-consuming and costly manner in order to program and set a new telecommunications terminal, the user is also forced to enter his/her personal data in the telephone book and address file for the telecommunications terminal.

To avoid these time-consuming costly inputs and settings, a USB interface 7, which is, preferably, in the form of a USB port and can be connected to the USB connector 81 of the USB memory stick 8, is, according to the invention, provided on the housing 2 of the mobile part 1. In addition to the USB connector 81, with contacts for a digital data transfer, the USB memory stick 8 has a memory 82, which is disposed in the housing 80, and, possibly, a USB controller 83. The USB interface 7 can be disposed directly on the housing periphery so that the housing 80 of the USB memory stick 8 projects from the housing 2 of the mobile part 1 or is integrated in the housing 2 so that the USB memory stick 8 is inserted into the housing 2 of the mobile part 1 through an insert slot 20, and the USB connector 81 is connected to the USB interface 7, which is disposed at the end of the insert slot.

Locking, which prevents inadvertent disconnection of the USB memory stick 8 from the housing 2 of the mobile part 1, may be provided both for integration of the USB memory stick 8 in the housing 2 of the mobile part 1 and connection of the USB memory stick 8 to the mobile part 1 so that it projects from the housing 2 of the mobile part 1.

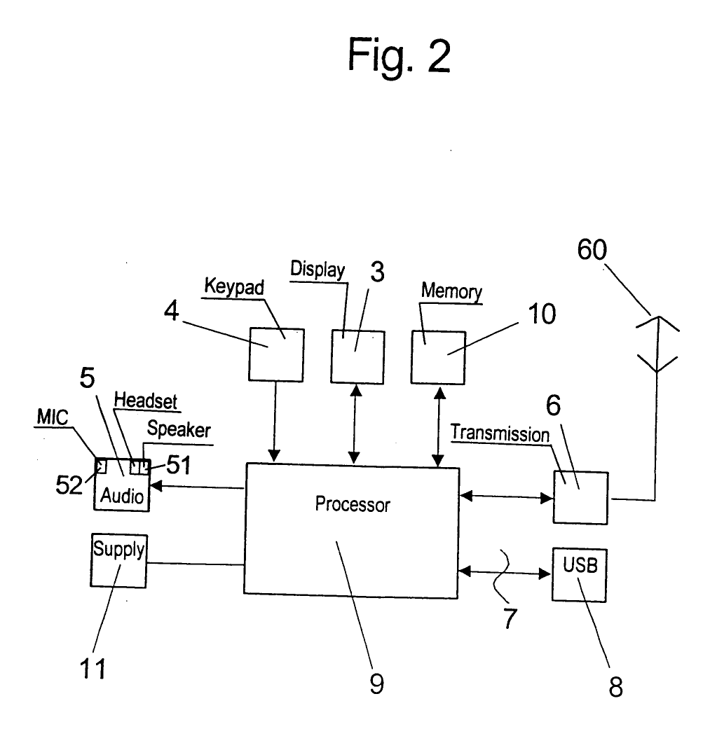

FIG. 2 shows a block diagram of the individual functional parts of the mobile part 1 illustrated in FIG. 1.

A microprocessor or baseband controller 9 is connected not only to a keypad 4, to a display 3, to an internal memory module 10, to an audio interface 5 with the loudspeaker 51 and to the microphone 52 as shown in FIG. 1, but also to a headset, a current/voltage supply 11 with a voltage regulator and a charging device, as well as a radio transmission module 6. The baseband controller 9 is also connected to the USB interface 7, 8, downstream from which, if required, a USB controller is connected if the baseband controller 9 does not carry out this task.

Regardless of whether or not the USB memory stick 8 is permanently or temporarily connected to the mobile part 1, the USB memory stick 8 stores the functional and setting parameters as well as the individual user data for the mobile part 1. If the USB memory stick 8 is permanently connected to the mobile part 1, the data, functional, and setting parameters that are stored in the USB memory stick 8 are made available to the electronic data processing components of the telecommunications terminal and, in such a case, are made available in particular to the baseband controller 9 or are transmitted to the memory module 10 in the mobile part 1.

If no permanent connection is provided between the USB memory stick 8 and the mobile part 1, then the baseband controller 9 accesses the memory 82 in the USB memory stick 8 when accessing the functional and setting parameters and the data for the mobile part or of the network operator, whose stored data is matched to the data stored in the USB memory stick 8, when the USB memory stick 8 is connected to the telecommunications terminal or mobile part 1 through the USB interface 7.

Because the data, functional, and setting parameters are permanently stored in the USB memory stick 8, the data, functional, and setting parameters can be transmitted to some other telecommunications terminal, or possibly to an electronic data processing device, in the event of servicing or repair, or replacement of the mobile part, by connecting the USB memory stick 8 to the relevant telecommunications terminal or computer processing device through an appropriate USB interface. This means that there is no need to manually re-enter functional and setting parameters as well as individual user data in a new mobile part, and with the aid of a servicing technician, in situ.

1. A telecommunications terminal, comprising:
a bi-directional communication device having data, functional, and setting parameters;
a storage apparatus connected to said communication device and storing said data, functional, and setting parameters of said communication device;
a Universal Serial Bus (USB) interface connected to at least one of said communication device and said storage apparatus;
a USB memory stick removably connected to said USB interface; and
said storage apparatus storing said data, functional and setting parameters of said communication device on said USB memory stick through said USB interface.

2. The telecommunications terminal according to claim 1, wherein said USB memory stick stores data for said communication device selected from at least one of the group consisting of telephone book data, short messages data, access code data, authorization data, and authorization words.

3. The telecommunications terminal according to claim 1, wherein:
said communication device has functional parts; and
said USB memory stick is connected to said functional parts through said USB interface.

4. The telecommunications terminal according to claim 3, wherein:
said communication device has an internal memory unit; and
said USB memory stick is connected to said memory unit through said USB interface.

5. The telecommunications terminal according to claim 4, wherein said memory unit is a memory selected from the group consisting of RAM and FLASH memory.

6. The telecommunications terminal according to claim 1, wherein said USB memory stick is a USB memory stick duo.

7. The telecommunications terminal according to claim 1, further comprising a USB controller, said USB memory stick being connected to said USB interface through said USB controller.

8. The telecommunications terminal according to claim 7, further comprising a serial memory, said USB controller being connected to said serial memory.

9. The telecommunications terminal according to claim 8, wherein said serial memory is an EEPROM.

10. The telecommunications terminal according to claim 1, wherein said USB memory stick has a USB controller and is connected to said USB interface through said USB controller.

11. The telecommunications terminal according to claim 10, wherein said USB memory stick has a serial memory connected to said USB controller.

12. The telecommunications terminal according to claim 11, wherein said serial memory is an EEPROM.

13. The telecommunications terminal according to claim 1, further comprising a housing having an insert slot configured to removably receive said USB memory stick, said communication device, said storage apparatus and said USB interface being disposed in said housing.

14. The telecommunications terminal according to claim 13, wherein said USB memory stick is lockably connected to said USB interface.

15. The telecommunications terminal according to claim 13, wherein:
said USB interface has a lock; and
said lock selectively locks said USB memory stick in said USB interface.

16. The telecommunications terminal according to claim 13, wherein:
said housing has a face; and
said USB memory stick is removably connected to said insert slot to end flush with said face.

17. The telecommunications terminal according to claim 1, wherein said communication device is selected from the group consisting of a cordless telephone, a DECT Standard cordless telephone, a table telephone, and a mobile telephone.

18. A telecommunications terminal, comprising:
a bi-directional communication device having data, functional, and setting parameters;
a Universal Serial Bus (USB) interface;
a USB memory stick removably connected to said USB interface; and
a means for storing said data, functional, and setting parameters of said communication device on said USB memory stick through said USB interface, said storage means connected to said communication device and to said USB interface.

19. A telecommunications terminal, comprising:
a bi-directional communication device having data, functional, and setting parameters;
a Universal Serial Bus (USB) interface connected to said communication device; and
a USB memory stick removably connected to said USB interface, said USB memory stick storing said data, functional, and setting parameters of said communication device and selectively transmitting said data, functional, and setting parameters of said communication device to said communication device through said USB interface.

20. A telecommunications terminal, comprising:
a bi-directional communication device having data, functional, and setting parameters;
a Universal Serial Bus (USB) interface connected to said communication device;
a USB memory stick removably connected to said USB interface, said USB memory stick storing said data, functional, and setting parameters of said communication device; and
said communication device reading said data, functional, and setting parameters from said USB memory stick through said USB interface.

21. A telecommunications terminal, comprising:
a Universal Serial Bus (USB) interface to be connected to a USB memory stick; and
an apparatus for storing data, functional, and setting parameters for the telecommunications terminal connected to said USB interface, said apparatus storing the parameters on the USB memory stick when connected to said USB interface.

22. A method for operating a telecommunications terminal, comprising:
providing a bi-directional communication device with data, functional, and setting parameters and a Universal Serial Bus (USB) interface;
removably connecting a USB memory stick to the USB interface; and
storing the data, functional, and setting parameters of the communication device on the USB memory stick through the USB interface.
